(19) United States
(12) Patent Application Publication
(10) Pub. No.: US 2012/0260237 A1
(43) Pub. Date: Oct. 11, 2012

(54) Portable Business Language and Automated Software Application Development System

(75) Inventors: Paul Duddles, San Diego, CA (US); Serge Bodrov, San Diego, CA (US); Ben Tohsakul, San Marcos, CA (US); Andrey Belyshev, San Diego, CA (US)

(73) Assignee: REQUIREMENTSLIVE LLC, La Jolla, CA (US)

(21) Appl. No.: 13/442,374

(22) Filed: Apr. 9, 2012

Related U.S. Application Data
(60) Provisional application No. 61/473,787, filed on Apr. 10, 2011.

(51) Int. Cl. G06F 9/45

(52) U.S. Cl. 717/139

(57) ABSTRACT

A portable business language and automated software development system comprises one or more servers containing a set of requirement inputs and an application engine residing on at least one of the one or more servers. The application engine comprises a requirements input component receiving a subset of the set of requirement inputs, a compiler component transforming the subset of the set of requirement inputs into one or more machine-readable codes, and a preparation component. The preparation component uses one of the one or more machine-readable codes to prepare a user interaction device to execute a final application, prepare a memory of the one or more servers to store data that may be provided by a user of the user interaction device, and transform the one or more machine-readable codes into an interpreted platform-specific code having additional parameters that customize the interpreted platform-specific code for the platform.

### PRIORITY AND RELATED APPLICATIONS

This application claims priority to U.S. Provisional Patent Application No. 61/473,787 filed on Apr. 10, 2011 which is incorporated by reference into the present application in its entirety and for all proper purposes.

### FIELD OF THE INVENTION

Aspects of the present invention relates to software development. In particular, but not by way of limitation, aspects of the present invention relate to apparatus and methods for automatically transforming a set of user-selected requirements inputs into executable code or web applications that are executable on a variety of computing platforms, software environments and browser interfaces.

### BACKGROUND OF THE INVENTION

Enterprise or business software development usually involves considerable programming time and expertise. Either an experienced programmer inside a company or an external consultant is typically required. Either way, the programmer typically stands between those actually developing the application and the details of the program itself.

Additionally, applications have to be tailored to different platforms (e.g., PC, LINUX, MAC, JAVA, smartphone, IPAD, etc.). For instance, an application's particular executable code may run on a WINDOWS operating system, but not on a MAC. Similarly, a web-based application may operate as desired on a desktop PC, but may not be as functional if accessed via smartphone. Nor do platforms remain constant over time. Updates are a constant plague of any computer user, and are even more troublesome for application developers, since updates can render applications partially or fully inoperable. At the same time, there may be a desire to take advantage of new features and capabilities that updated platforms enable. Thus, application development is further complicated by the need to tailor applications to various platforms and repeatedly update code every time a platform updates.

The lack of direct control over application development and the expense and time associated with developing and maintaining applications, leaves many companies unwilling to invest in this traditional model of application development.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

In accordance with one aspect, a portable business language and automated software development system comprises one or more servers containing a set of requirement inputs and an application engine residing on at least one of the one or more servers. The application engine comprises a requirements input component receiving a subset of the set of requirement inputs, a compiler component transforming the subset of the set of requirement inputs into one or more machine-readable codes, and a preparation component. The preparation component uses one of the one or more machine-readable codes to prepare a user interaction device to execute a final application, prepare a memory of the one or more servers to store data that may be provided by a user of the user interaction device, and transform the one or more machine-readable codes into an interpreted platform-specific code having additional parameters that customize the interpreted platform-specific code for the platform.

In accordance with another aspect, a method of software development comprises receiving a plurality of requirement inputs selected from a set of text and visual requirement inputs, transforming the plurality of requirement inputs into one or more machine-readable codes, passing the one or more machine-readable codes to a user interaction device and a memory of the one or more servers, preparing the user interaction device to execute an interpreted platform-specific executable based on at least one of the one or more machine-readable codes, preparing the memory to store inputs from the user interaction device based on at least one of the one or more machine-readable codes, generating an interpreted platform-specific code from the one or more machine-readable codes, and executing the interpreted platform-specific code on the user interaction device.

### BRIEF DESCRIPTION OF THE DRAWING FIGURES

Various objects and advantages and a more complete understanding of the present invention are apparent and more readily appreciated by referring to the following detailed description and to the appended claims when taken in conjunction with the accompanying drawings:

FIG. 1 is an application engine constructed in accordance with aspects of the present invention;

FIG. 2 is a embodiment of a method in accordance with aspects of the present invention;

FIG. 3 shows an exemplary set of requirement inputs in accordance with aspects of the present invention;

FIG. 4 shows a diagrammatic overview of aspects of the present invention; and

FIG. 5 is a diagrammatic representation of one embodiment of a machine in the exemplary form of a computer system that may be used in connection with aspects of the present invention.

### DETAILED DESCRIPTION

This disclosure describes, among other aspects and embodiments, apparatus and methods for using a server-based application “agnostic” development engine to receive user commands selected from a simplified description-oriented code or portable business language, and automatically convert the overall desires embodied in those commands into executable code, custom web applications or other custom software applications that run on various platforms. More particularly, aspects of the present invention allow a simplified set of software instructions to be presented to a person responsible for developing software or applications for the corporation, but who does not need to have the technical expertise of a typical programmer (sometimes referred to herein as a “requirements developer”). These instructions, or as sometimes referred to herein as “requirements inputs” (or portable business language), may number in the dozens or a few hundred, for example. The number of instructions and complexity is such that a requirements developer can learn the entire language in a much shorter time (e.g., days versus weeks or even months). The requirement inputs roughly represent a form and function that the requirements developer desires in a final executable application. The requirements developer thus uses the set of requirement inputs to broadly describe the function and appearance of the final executable application.

In one example, an application engine residing on one or more remote servers takes the requirements inputs (for example a text and tag based declarative language) provided by the requirements developer via the Internet, or some other network, and transforms them into one or more machine-readable codes (or an input control document). The machine-readable code or input control document can be represented in any number of structured formats (e.g., XML). The computer-readable codes are platform and hardware agnostic, meaning the one or more servers build the final application specific code from the computer-readable codes. The application engine can then pass the one or more machine-readable codes to a user interaction device coupled to the Internet and to a memory of the one or more servers. The one or more machine-readable codes can be used to prepare the user interaction device to execute the final application. The one or more machine-readable codes can also be stored in the memory and used to prepare the memory to store inputs that a user of the final application may provide in the future via the user interaction device.

The application engine can then generate a final executable application from the one or more machine-readable codes. This generation process has two aspects: (1) generation of an interpreted platform-specific executable for each of a plurality of platforms; and (2) addition of parameters to the executable that allow each interpreted platform-specific executable to achieve the goals of the requirements developer as well as taking advantage of unique aspects of each platform. In other words, the final executable application can execute on a variety of platforms, and will have a form and function adapted for each platform. The interpreted platform-specific executable can then execute on the user interaction device and allow an application user to use the final application regardless of the platform that the user interaction device uses.

Previously, an application might have to be updated whenever a platform was updated or when an application had to run on a new platform. This process is costly in terms of time and money, because an experienced programmer has to work on code for a plurality of businesses. This disclosure overcomes this resource drain by making all such changes and updates in the application engine rather than at the requirements developer level. In other words, the requirement inputs do not change, while the final applications adapt to various platforms and platform updates.

Thus, rather than each business having to update or rewrite its code for every platform update or new platform, such updates and new code can be dealt with one time in the application engine. The updates and new code can then be applied in mass to all business users of the application engine via one-time updates within the application engine.

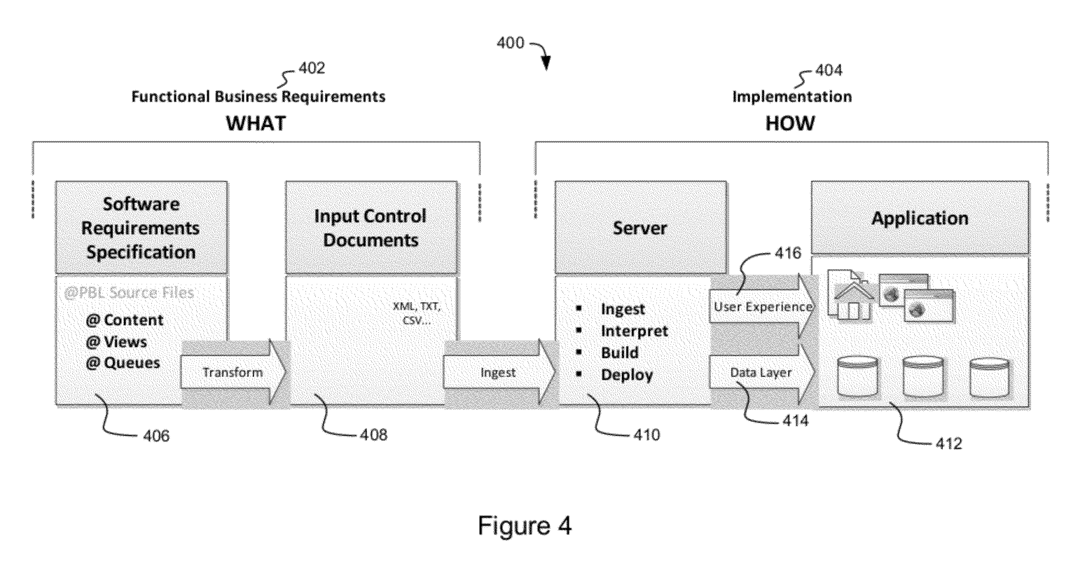

This is possible because of an agnostic abstraction at the requirements developer input level. The requirement inputs specify what the final application should do, but not how (see e.g., FIG. 4). If a requirements developer wants an inventory management form in its application, then it will specify this general desire with the requirement inputs. The application engine figures out how to implement this general desire in executable code. The end product or final application will have an inventory management form, but the form will be slightly different for each platform and may change over time as platforms are updated. These updates to the final application can come without any action by the requirements developer. Rather, it is the few programmers who can keep the application engine updated that enable these updates simultaneously for all business clients using the application engine.

This disclosure thus simplifies application development for the business client, provides an inexpensive and timely means for creating applications that can run on any of a variety of platforms, and provides application longevity by preventing an application from becoming inoperable as platforms are updated and new platforms are introduced.

In one embodiment, the application engine is a set of software components configured to receive the subset of requirement inputs, and transform them into a final application (comprising one or more interpreted platform-specific executables).

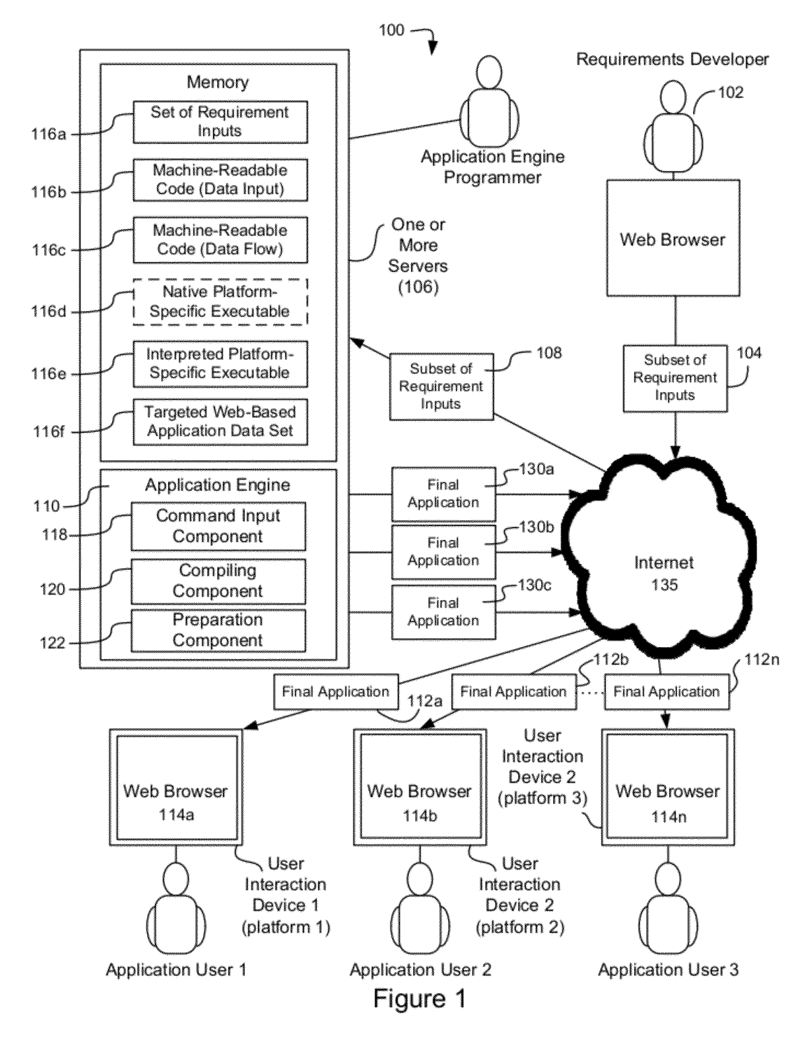

FIG. 1 illustrates an embodiment of an application engine 100 constructed in accordance with aspects of the present invention. In the illustrated embodiment, a requirements developer 102 selects a subset of requirement inputs 104 describing a form and function of a final application, but without specifying details (e.g., button locations, background colors, style of textbox, etc.). One or more servers 106 can receive a subset of requirement inputs, and an application engine 110 on the one or more servers 106 can convert the subset of requirement inputs into a plurality of final applications 112a, 112b through 112n that are passed to a plurality of one or more user interaction devices 114a, 114b through 114n. While the final application can have roughly the same form and function no matter what user interaction device it runs on, details may differ slightly since the application engine produces a unique code (interpreted platform-specific executable) for each platform. In the illustrated embodiment, the final application runs on three different platforms, and thus three different codes will be executing on the one or more servers. However, it is contemplated that the application engine 110 is capable of producing “n” number of unique platform-specific executable codes.

In the illustrated embodiment, the requirements developer uses a web browser (e.g., a WIKI or other web editor) to select a subset of requirement inputs describing a general form and function of a desired final application. The requirements developer need not have knowledge in any coding language or software development other than an understanding of the set of requirement inputs. Requirement inputs can be textual tags (words or phrases) or visual inputs (e.g., a textbox movable via mouse, a resizable button) that describe form or function of an application. The full set of requirement inputs can be stored in a memory 116 of the one or more servers, where the servers are coupled to the requirements developer's web browser via the Internet or some other network. The memory 116 is adapted to include the ability to store information relating to a set of requirement inputs 116a, machine readable code embodied as data input 116b, machine readable code embodied as data flow 116c, a native platform-specific executable 116d, an interpreted platform-specific executable 116e, and a targeted web-based application data set 116f.

Each requirement input can be associated with a plurality of machine-readable code. For instance, a requirement input, with the designation of “textbox” can be transformed into dozens of lines of XML or other code that when executed displays a text box on an application user's computer screen. In another embodiment, rather than each requirement input being associated with a specific set of machine-readable code, a combination of requirement inputs may be associated with a specific set of machine-readable code. In this way a final application will vary depending on the combination of requirement inputs used, not just which individual requirement inputs are used. For instance, the requirement inputs “textbox” and “entry form” may be transformed into code that when executed displays a textbox for data entry. In contrast, when “textbox” and “document title” are used together, the resulting executable may merely display a document title as defined by the requirements developer, but without any user input capability.

Requirement inputs can be selected, for instance, via an Internet editing interface such as a WIKI editor or other known plain language editor. One advantage of an editor such as a WIKI editor is to enable collaboration between one or more requirements developers since each requirements developer can suggest changes, and in one embodiment, changes will not be implemented unless approved by a threshold portion of all requirements developers within a development group (e.g., a company). Other editing environments are contemplated by aspects of the present invention, such as one or more of the following:

An online web-based IDE that provides version control, PBL syntax help, and other development tools. A wild editor would be one example that exposes these features in collaborative environment.

A desktop-based IDE that provides online or offline development, version control, PBL syntax help, and other development tools. Eclipse is one example that exposes these features.

A developer API interface that exposes similar functionality as an IDE but through a programmatic interface rather than a viusual or text editor. An example would be a web service that exposes various functions to enable application development.

In another embodiment, requirement inputs give the requirements developer control over such features such as content, data, business logic, workflow, events, presentation, and graphics. However, control over persistence (or data storage), data retrieval, and exports are taken out of the hands of the requirements developer and are reserved for the application engine 110. This creates separation between the application and data layers and insulates the requirements developer from the complexities of typical database-driven applications.

Memory 116 can reside on a single server or be distributed amongst one or more servers. The application engine 110 may be indifferent to the form of memory and the method used to store data to the memory. This isolation from the memory further enables the application engine to be portable from one set of servers to another. In other words, the application engine is agnostic with regards to the hardware on which it runs.

The selected subset of requirement inputs can pass through the Internet to one or more servers in which the application engine 110 and memory 116 reside. A command input component 118 of the application engine 110 can receive the subset of requirement inputs, and a compiling component 120, can transform the subset of requirement inputs into one or more machine-readable codes. For instance, the requirement inputs can be transformed into a machine-readable code representing data inputs of the final application and a machine-readable code representing data flow of the final application. In other words, the functions of data intake and data flow within the final application can be separated into two separate machine-readable codes.

The application engine, via a preparation component 122 using the one or more machine-readable codes, prepares one or more user interaction devices to run the final application. The preparation component 122 can also use the one or more machine-readable codes to prepare the memory on the servers to store inputs that may be provided by users using the final application. The one or more machine-readable codes may also be stored in the memory.

The application engine 110 generates a final application (e.g. 112a, 112b through 112n) from the one or more machine-readable codes, which can be done at runtime in an embodiment. By use of the term “final application”, it is meant to describe the general look and feel of the program running on a computing device or user interaction device. The code that executes behind the scenes on the one or more servers 106 may vary depending on the platform on which the application runs. For instance, in the illustrated embodiment, application user 1 and application user 2 are using hardware running two different platforms—platform 1 and platform 2 (e.g., WINDOWS versus MAC or FIREFOX 3.0 versus FIREFOX 4.0 or a PC versus a smartphone). Although the application users will experience nearly identical final applications, the code that is being executed for user interaction device 1 is an interpreted executable specifically tailored for platform 1, while the code that is being executed for user interaction device 2 is an interpreted executable specifically tailored for platform 2.

In generating the final application, the application engine can add platform-specific code associated with form and function that is common to all applications. For instance, unless otherwise specific, all buttons may have gray and black shaded borders regardless of what type of button is called for or what the function of the button is. At the same time, the application engine can tailor buttons for a specified user if, for instance, the requirements developer requests a unique color scheme for the entire application.

The one or more interpreted platform-specific executables can execute on the one or more servers 106. The final application(s) 130a, 130b and 130c, which can vary for each platform, can pass over the Internet 135, or another network, to one or more user interaction devices where application users can utilize the final application(s).

In another embodiment, a user interaction device can run a final application whether or not the user interaction device is online or not (e.g., connected to the Internet or another network). This is because the application engine 110 is able to produce a single interpreted platform-specific executable for each platform, and such an executable can run when user interaction device is online or offline. In one embodiment, the application running offline can use limited resources so that it can run on web-based servers or on lower-computing-power standalone computers (e.g., personal computer). Also, the application running offline can be formed so that it duplicates all or substantially all functionality of the webserver onto the standalone computer and transfers all webserver files to the standalone computer before the standalone computer goes into offline mode.

One or more application engine programmers can monitor and update the application engine. These programmers can have knowledge of the numerous platforms in existence as well as updates to each platform. They can update the application engine to enable it to produce interpreted platform-specific executables for any number of platforms as well as updating the application engine to produce interpreted platform-specific executables that take advantage of new features of updated platforms and avoid inoperability due to those updates. In this way, actual changes to code for a slew of business clients can occur once, at the application engine level, rather than individually for each requirements developer. In contrast, current methods of updating code can involve programmers working individually with every business client to update and modify the client's unique code.

In another embodiment, the application engine 110 can transform the subset of requirement inputs into a native platform-specific executable rather than first creating machine-readable code and then transforming the machine-readable code into an interpreted platform-specific executable. The native platform-specific executable can be created before runtime, another contrast with the creation of interpreted platform-specific executables. Native platform-specific executables are written, compiled, or assembled to run on a particular platform.

In another embodiment, the application engine can add compliance-specific features to the machine-readable code or the interpretable platform-specific executables that it generates. Such compliance-specific features can include findings, corrective actions, preventative actions, status-driven workflows, and automatic audit-trails for use in systems that operate in process workflow environments such as business process automation, Supply Chain Management, Business Planning and Franchisee management, etc.

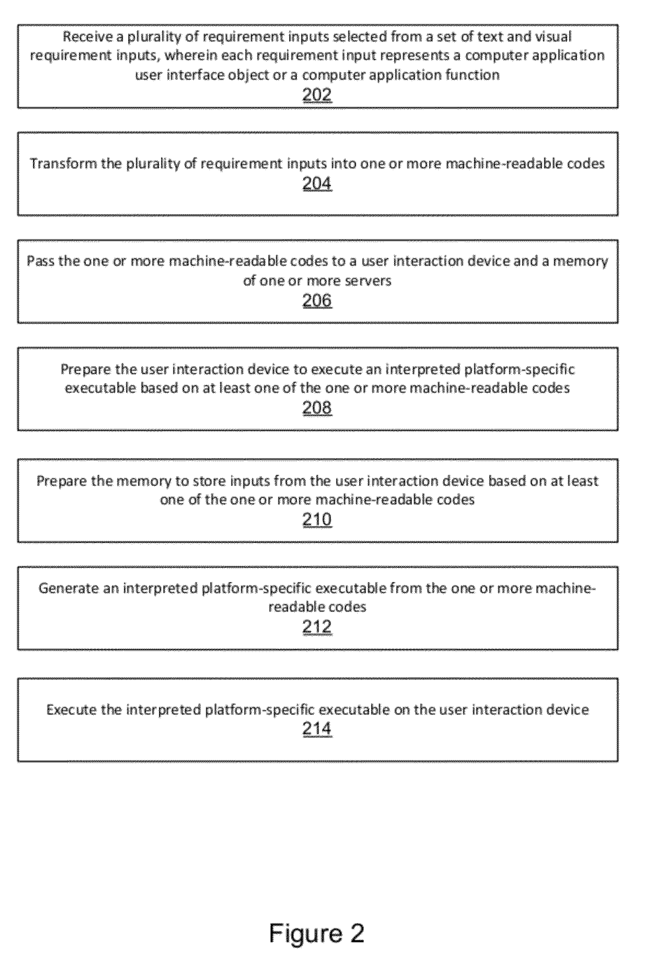

FIG. 2 illustrates an embodiment of a method 200 for using an application engine to convert a subset of requirement inputs into one or more interpreted platform-specific executables. The method 200 includes a receive operation 202 in which a plurality of requirement inputs are received in one or more remote servers. The requirement inputs are selected from a set of text and visual requirement inputs residing on a memory of the one or more servers. The text and visual requirement inputs represent desired form and function of a final application.

The method 200 further includes a transform operation 204 in which the plurality of requirement inputs are transformed into one or more machine-readable codes (e.g., XML). In an embodiment, one machine-readable code represents desired data input functionality, and another machine-readable code represents desired data flow functionality.

The method 200 further includes a pass operation 206 in which the one or more machine-readable codes are passed to a user interaction device (e.g., a smartphone, PC, Web, iPAD, Tablet PC, etc.) and the memory of the one or more servers.

The method 200 further includes a first prepare operation 208, which prepares one or more user interaction devices to run a final application that will run based on the one or more machine-readable codes. While there is one final application, the final application may appear and function differently on different platforms. This is because the code executing on the one or more servers in order for the final application to run, can differ depending on the platform. This code, which is specific to different platforms, is called an interpreted platform-specific executable.

The method 200 includes a second prepare operation 210, which can prepare the memory of the one or more servers to store data inputs that may be received from the one or more user interaction devices as application users utilize the final application. This preparation operation 210 can be based on at least one of the machine-readable codes.

The method 200 further includes a generate operation 212 in which one or more interpreted platform-specific executables (e.g., in HTML or Java) can be generated from the one or more machine-readable codes. This generation can take place at runtime.

The method 200 also includes an execute operation 214. The execute operation 214 can execute the one or more interpreted platform-specific executables on the one or more user interaction devices.

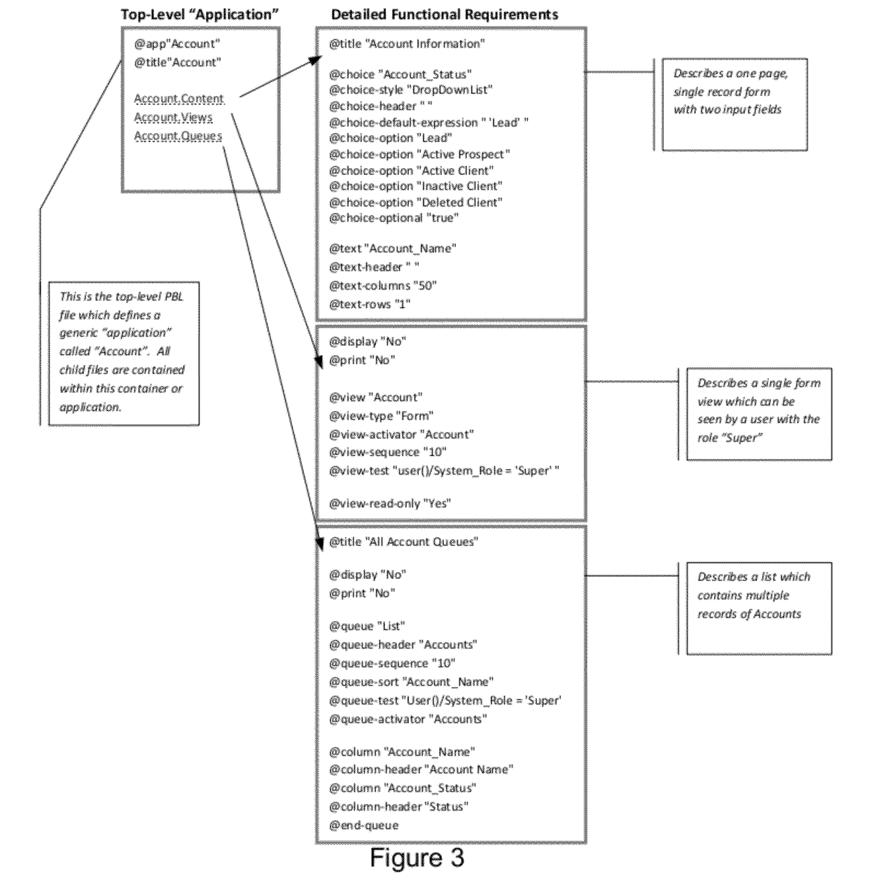

FIG. 3 illustrates an exemplary set of requirement inputs for capturing, editing, storing, and retrieving information for one embodiment of a customer account. The arrows represent the relationships and hierarchy between different requirement inputs files.

The Table 1 illustrates a set of exemplary requirement inputs (or a portable business language) that are neither exclusive nor intended to limit the scope of the requirement inputs described in this disclosure. Requirement inputs are displayed in the left-hand column, and a description of the requirement inputs in the right-hand column. As described above, the use of this type of agnostic requirements input allows the generation of a user application that may be output to a variety of executable operating environments (e.g. PC, Mac, Linux, etc.) or web based interfaces (e.g. browser environments).

TABLE 1

| Requirement Input | Description |
|---|---|
| action | Defines an action or multiple actions or options for a user to |
| | choose from or confirm or deny. |
| action “DrillDown” | A toggle action option that allows a user to hide or display |
| | items interactively. |
| app | Creates an application (wiki) that will be called |
| | “Application_Name”. What this application does will be |
| | defined by the PBL tags in its Contents, Views, and Queues. |
| app Template | Basic template used to establish a new application. @app |
| | “Application_Name” names the application; @title “Name” |
| | is the name/title of the application that will actually display |
| | as the application name/title. |
| app-ui-style | Defines the style of the application user interface. |
| block | Designates a block of text or paragraph of information set |
| | off by a line break before and after (e.g., ‘H1’ in HTML). |
| | Display or not display block using @block-visible-when |
| | “Choice = ‘Yes’\|‘No’” |
| block-container | Use to display an @block of information or paragraph |
| | enclosed in a banner. |
| block-navigate | Use to navigate to a block of information or paragraph |
| | located at/in “AppName.QueueName”; that is, located in the |
| | named queue in the named application. |
| button | Creates a button in a user interface with purpose and |
| | functionality determined by subordinate tags. |
| button will cause navigation to home | Determines that clicking button will take the user to the |
| | application Home page. |
| button will cause page reload/refresh | Determines that clicking the button will reload or refresh the |
| | current application page. |
| button will cause validation | Determines that clicking the button will cause validation of |
| | the form (required fields, text box validation, etc.) |
| button will close the form | Determines that clicking the button will close the form. |
| button-image | Determines the visual display or design of the button |
| | according to the .jpg file inserted in the @button-image |
| | “[[Image:Image1.jpg]]” double brackets. |
| button-style | Determines the style of button that displays in the UI. See |
| | Examples below for style samples. |
| checkbox | Creates a text box and determines the checkbox header, if |
| | applicable, and the text that will display adjacent to the |
| | checkbox. |
| choice “RadioButtonList” | Defines a field that will provide choices for the user in a |
| | radio button list. |
| choice “Yes/No Question” | Defines a choice option that will prompt the user for a yes or |
| | no answer. |
| choice “CheckBoxList” | Defines a field that will provide choices for the user in a |
| | check box list. |
| choice “DropDownList” | Defines a field that will provide choices for the user in a |
| | drop-down list. |
| choice-access-tag | Defines a choice option that will take the user to named Tag. |
| choice-columns | Defines the number of columns within an @choice tag |
| | string. |
| choice-default-expression | Defines which choice will display when creating a new entity. |
| choice-direction | Determines if the choice options display vertically or |
| | horizontally in the UI. |
| choice-header “name” | Defines the name of an @choice field or list. |
| choice-option | Names one of the options in an @choice list, such as an |
| | option in an @choice-style “DropDownList”. |
| choice-optional | Determines whether an @choice field in a form or dialog box |
| | is required or optional to be filled out by the user. If no, user |
| | will not be able to exit/save without filling out this field. |
| choice-rows | Defines the number of rows within an @choice tag string. |
| choice-style | Defines the style of an @choice field, such as a drop-down |
| | list, check box list, or radio button list. |
| column | Creates or adds a new column. Serves as a parent tag with |
| | specifications of the column determined by subordinate |
| | child tags. |
| column-aggregate | Designates the column aggregate operation to be |
| | performed. |
| column-aggregate-format | Enter the specifications for column aggregation using |
| | standard numeric format. |
| column-empty-value | Designates the display of “n/a” in a column field when no |
| | value has been entered. |
| column-filter-values | Determines the value(s) which filters data in a column. |
| column-format | Specifies the alphanumeric format for column information. |
| column-header | Determines the actual text that displays as the header of a |
| | column. Nests underneath the @column “Column_Name” |
| | tag. |
| column-hidden | Toggles the option to hide or display a column. |
| column-select | Provides for an XPath expression to be used to define the |
| | column. |
| column-size | Specifies the width of a column. |
| column-type | Determines the type of information that will display in a |
| | column. See options in Template below. |
| comment | Insert explanatory or query comments within language |
| | string. Does not display or affect tag specifications. |
| data | Defines the workbook name to be used to display an entity. |
| | Used when sending entities to other sites. |
| description | Places a name or title above a dialog box, field, or other UI |
| | element. |
| display | Choose whether to display or not (Yes\|No). |
| queue | Creates a queue named “Queue_Name”. The actual name |
| | that displays for the queue is determined by the tag, |
| | @queue-header “Queue Header Text”. The @queue tag is a |
| | parent tag with the properties of the queue defined by the |
| | child tags below. |
| queue-advanced-search | Creates the ability to perform an Advanced Search on a |
| | queue. |
| queue-allow-new | Defines whether new entities can be created when viewing |
| | this queue. |
| queue-filter | Filters and displays all fields/columns/rows that fit the |
| | condition specified. |
| queue-footer | Defines the displayable footer [“Queue footer name”]. |
| queue-header | Determines the text that displays as the title of the queue. |
| queue-new-text | Names the option for creating a new queue entry. For |
| | example, in this PBL Dictionary, see Home page button |
| | under Actions: “Create new tag”. |
| queue-row-ui-style | Determines the style of row that display in a queue. |
| queue-sort | Defines the criteria by which the queue data is sorted. |
| queue-test | Performs a test against the designated user application. |
| queue-width | Defines the width of a queue in pixels. |
| table | Create a new table. Customize columns, rows, fonts, |
| | formatting, titles, etc. |
| text | Create a text box. |
| title | Names the title of an application or wiki. |
| view-read-only | Determines whether changes can be made to the respective |
| | @View. |

FIG. 4 shows a diagrammatic overview of how a server-based application agnostic development system 400 constructed in accordance with aspects of the present invention is formatted and constructed. The system 400 is generally divided into two components, a functional business requirements component 402 and an implementation component 404. The business requirements component 402 generally captures and defines the “what” of the desired application and the implementation component 404 generally determines and implements the “how” of the desired application.

Functional Business Requirements component 402 includes a module 406 that defines the specifications of the software requirements and transforms these specifications to a module 408 that converts these requirements to input control documents such as xml, csv or txt documents and files.

Implementation component 404 includes a server module 410 that ingests the input control documents from module 408 and adds functional aspects such as a data layer 414 and a user experience feature 416 before finalizing the information and generating a specific application at module 412.

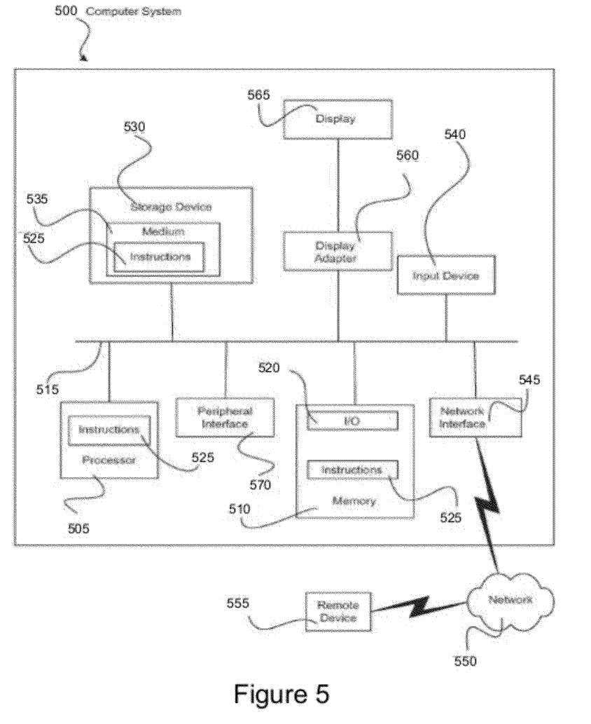

FIG. 5 shows a diagrammatic representation of one embodiment of a machine in the exemplary form of a computer system 500 within which a set of instructions for causing the device to perform any one or more of the aspects and/or methodologies of the present disclosure may be executed. Computer system 500 includes a processor 505 and a memory 510 that communicate with each other, and with other components, via a bus 515. Bus 515 may include any of several types of bus structures including, but not limited to, a memory bus, a memory controller, a peripheral bus, a local bus, and any combinations thereof, using any of a variety of bus architectures.

Memory 510 may include various components (e.g., machine readable media) including, but not limited to, a random access memory component (e.g., a static RAM “SRAM”, a dynamic RAM “DRAM, etc.), a read only component, and any combinations thereof. In one example, a basic input/output system 520 (BIOS), including basic routines that help to transfer information between elements within computer system 500, such as during start-up, may be stored in memory 510. Memory 510 may also include (e.g., stored on one or more machine-readable media) instructions (e.g., software) 525 embodying any one or more of the aspects and/or methodologies of the present disclosure. In another example, memory 510 may further include any number of program modules including, but not limited to, an operating system, one or more application programs, other program modules, program data, and any combinations thereof.

Computer system 500 may also include a storage device 530. Examples of a storage device (e.g., storage device 530) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 530 may be connected to bus 515 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 530 may be removably interfaced with computer system 500 (e.g., via an external port connector (not shown)). Particularly, storage device 530 and an associated machine-readable medium 535 may provide nonvolatile and/or volatile storage of machine-readable instructions, data structures, program modules, and/or other data for computer system 500. In one example, software 525 may reside, completely or partially, within machine-readable medium 535. In another example, software 525 may reside, completely or partially, within processor 505. Computer system 500 may also include an input device 540. In one example, a user of computer system 500 may enter commands and/or other information into computer system 500 via input device 540. Examples of an input device 540 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. Input device 540 may be interfaced to bus 515 via any of a variety of interfaces (not shown) including, but not limited to, a serial interface, a parallel interface, a game port, a USB interface, a FIREWIRE interface, a direct interface to bus 515, and any combinations thereof.

A user may also input commands and/or other information to computer system 500 via storage device 530 (e.g., a removable disk drive, a flash drive, etc.) and/or a network interface device 545. A network interface device, such as network interface device 545 may be utilized for connecting computer system 500 to one or more of a variety of networks, such as network 550, and one or more remote devices 555 connected thereto. Examples of a network interface device include, but are not limited to, a network interface card, a modem, and any combination thereof. Examples of a network or network segment include, but are not limited to, a wide area network (e.g., the Internet, an enterprise network), a local area network (e.g., a network associated with an office, a building, a campus or other relatively small geographic space), a telephone network, a direct connection between two computing devices, and any combinations thereof. A network, such as network 550, may employ a wired and/or a wireless mode of communication. In general, any network topology may be used. Information (e.g., data, software 525, etc.) may be communicated to and/or from computer system 500 via network interface device 545.

Computer system 500 may further include a video display adapter 560 for communicating a displayable image to a display device, such as display device 565. A display device may be utilized to display any number and/or variety of indicators related to pollution impact and/or pollution offset attributable to a consumer, as discussed above. Examples of a display device include, but are not limited to, a liquid crystal display (LCD), a cathode ray tube (CRT), a plasma display, and any combinations thereof. In addition to a display device, a computer system 500 may include one or more other peripheral output devices including, but not limited to, an audio speaker, a printer, and any combinations thereof. Such peripheral output devices may be connected to bus 515 via a peripheral interface 570. Examples of a peripheral interface include, but are not limited to, a serial port, a USB connection, a FIREWIRE connection, a parallel connection, and any combinations thereof. In one example an audio device may provide audio related to data of computer system 500 (e.g., data representing an indicator related to pollution impact and/or pollution offset attributable to a consumer).

A digitizer (not shown) and an accompanying stylus, if needed, may be included in order to digitally capture freehand input. A pen digitizer may be separately configured or coextensive with a display area of display device 565. Accordingly, a digitizer may be integrated with display device 565, or may exist as a separate device overlaying or otherwise appended to display device 565.

Those skilled in the art can readily recognize that numerous variations and substitutions may be made in the invention, its use, and its configuration to achieve substantially the same results as achieved by the embodiments described herein. Accordingly, there is no intention to limit the invention to the disclosed exemplary forms. Many variations, modifications, and alternative constructions fall within the scope and spirit of the disclosed invention.

What is claimed is:

1. A method comprising:
receiving a plurality of requirement inputs selected from a set of text and visual requirement inputs, wherein each requirement input represents one of a computer application user interface object and a computer application function;
transforming the plurality of requirement inputs into one or more machine-readable codes;
passing the one or more machine-readable codes to a user interaction device and a memory of the one or more servers, wherein the user interaction device is coupled to the one or more servers via the Internet;
preparing the user interaction device to execute an interpreted platform-specific executable based on at least one of the one or more machine-readable codes;
preparing the memory to store inputs from the user interaction device based on at least one of the one or more machine-readable codes;
generating an interpreted platform-specific code from the one or more machine-readable codes, wherein the generating includes addition of parameters to the interpreted platform-specific code that customize the interpreted platform-specific code for the platform;
executing the interpreted platform-specific code on the user interaction device.

2. The method of claim 1, wherein the one or more machine-readable codes each comprise a data collection portion and a data flow portion.

3. The method of claim 1, wherein the interpreted platform-specific code is an executable code.

4. The method of claim 1, wherein the interpreted platform-specific code is a web application code.

5. The method of claim 3, wherein the executable code is adapted to run on one of a plurality of computer operating systems.

6. The method of claim 5, wherein the computer operating systems are selected from the group consisting of UNIX, Windows, Mac OSX, Google Chrome, and Linux.

7. The method of claim 4, wherein the web application code is selected from the group consisting of XML, Java, JavaScript, HTML, mySQL, Flash, ActiveX, CSS, and PHP.

8. The method of claim 1, wherein the web application code is adapted to run on a mobile device.

9. The method of claim 1, wherein the one or more machine-readable codes are functionally agnostic to the user interaction device.

10. The method of claim 1, wherein the interpreted platform-specific code is particular to the user interaction device.

11. A system comprising:
One or more servers containing a set of requirement inputs;
an application engine residing on at least one of the one or more servers, the application engine comprising:
a requirements input component receiving a subset of the set of requirement inputs;
a compiler component transforming the subset of the set of requirement inputs into one or more machine-readable codes; and
a preparation component that uses one of the one or more machine-readable codes to:
prepare a user interaction device to execute a final application;
prepare a memory of the one or more servers to store data that may be provided by a user of the user interaction device; and
transform the one or more machine-readable codes into an interpreted platform-specific code having additional parameters that customize the interpreted platform-specific code for the platform.

12. The system of claim 11, wherein the interpreted platform-specific executable is executed by a user interaction device that is either coupled or decoupled to the Internet.

13. The system of claim 11, wherein the application engine generates a native platform-specific executable from the subset of the set of requirement inputs.

14. The system of claim 11, wherein the application engine is modified to generate the interpreted platform-specific executable for a newly-developed platform.

15. The method of claim 11, wherein the interpreted platform-specific code is an executable code.

16. The method of claim 11, wherein the interpreted platform-specific code is a web application code.

17. The method of claim 15, wherein the executable code is adapted to run on one of a plurality of computer operating systems.

18. The method of claim 17, wherein the computer operating systems are selected from the group consisting of UNIX, Windows, Mac OSX, Google Chrome, and Linux.

19. The method of claim 16, wherein the web application code is selected from the group consisting of XML, Java, JavaScript, HTML, mySQL, Flash, ActiveX, CSS, and PHP.

20. The method of claim 16, wherein the web application code is adapted to run on a mobile device.
